(19) United States
(12) Patent Application Publication
(10) Pub. No.: US 2022/0279624 A1
(43) Pub. Date: Sep. 1, 2022

(54) Electric Heating Device

(71) Applicant: Eberspächer catem GmbH & Co. KG, Herxheim (DE)

(72) Inventors: Karsten Bolz, Kandel (DE); Dietmar Wunstorf, Hildesheim (DE)

(21) Appl. No.: 17/682,108

(22) Filed: Feb. 28, 2022

(30) Foreign Application Priority Data
Feb. 26, 2021 (DE) 10 2021 104 680.7

(51) Int. Cl. H05B 3/06; F24H 1/10; F24H 3/00

(52) U.S. Cl. CPC H05B 3/06; F24H 1/102; F24H 3/002; F24H 2250/04

(57) ABSTRACT

An electric heating device includes a housing forming a receptacle and a fluid channel The receptable holds a PTC element. In order to reduce weight and assembly effort, the housing is formed by a uniform extruded profile.

### BACKGROUND OF THE INVENTION

### 1. Field of the Invention

The present invention relates to an electric heating device with a housing forming a receptacle holding a PTC element and a fluid channel

### 2. Background of the Invention

Such a housing is known for a water heater from EP 2 637 474 A1. EP 1 872 698 A1 also discloses a generic electric heating device, the subject matter of each of which is hereby incorporated herein by reference.

### SUMMARY

The problem underlying the present invention is to provide an electric heating device which can be configured in a relatively weight-saving and simple manner with small dimensions.

In order to solve this problem, the present invention provides an electric heating device including a housing having a receptacle and a fluid channel. A PCT element is held in the receptacle. The housing is formed by a uniform extruded profile.

This uniform extruded profile is usually formed from metal, for example aluminum or an aluminum alloy, which has a relatively low density with good thermal conductivity. The PTC element may be held in the receptacle in a generally known manner In this context, one or more PTC elements may be provided in a position frame which holds the PTC element in position. This position frame can be made of plastic and be provided between strip conductors, which usually energize the PTC element on opposite sides. Between these strip conductors and the opposing inner surfaces of the receptacle, via which the heat generated by the PTC element is conducted out of the receptacle, there can be insulation. This insulation may be formed by a plastic film and/or a ceramic plate. Said inner surface usually extends parallel or substantially parallel to a main side surface of the PTC element. Thus, the receptacle forms two inner surfaces which usually completely cover the main side surfaces of the PTC element.

Extrusion in the sense of the present invention is also pultrusion. It only depends on the fact that the housing is produced as a profile part with complex geometry by molding in a press die and cut to length. The housing is extruded accordingly and is an explosion component.

The main side surface is the largest surface of the PTC element. It is usually configured as a cuboid. The main side surface is spanned by the width and length of the cuboid. The PTC element usually has two identical main side surfaces which are opposite each other and are connected by a circumferential edge extending in the height direction. The parts described above and provided in the receptacle comprising the PTC element, the strip conductors as well as the insulation are hereinafter also referred to as the PTC heating assembly.

The housing of the electric heating device according to the invention not only forms the receptacle for the PTC heating assembly. Rather, the housing also serves to guide the medium to be heated. Thus, the housing forms a heating chamber which has inlet and outlet openings through which the medium to be heated can pass into the housing. The fluid channel of the housing is formed between these two openings.

With respect to improved heat transfer of the heat generated by the PTC element, heating ribs project into the fluid channel These heating ribs are also part of and formed by the uniform extruded profile. The aforementioned inlet and outlet openings are created by cutting an extruded profile initially extruded as a continuous material. Accordingly, the housing usually has an identical cross-sectional configuration between the inlet and outlet openings.

With respect to the most uniform possible and thus bilateral extraction of the heat generated by the PTC element, the housing forms at least two fluid channels which form the receptacle between them. Subsequently, the heat-conducting inner surface adjacent to the PTC element is formed by a boundary wall which bounds a fluid channel

It is understood that opposite the inner surface, the heating ribs usually extend on both sides, substantially at right angles to the inner surface.

According to a preferred configuration of the present invention, the extruded profile of the electric heating device according to the invention also forms parts of a thermal insulation. This thermal insulation is provided on the outside of the respective fluid channels. Usually, this thermal insulation is formed by an insulation chamber provided between the outer wall of the housing and the fluid channel and formed by the extruded profile. Correspondingly formed insulation chambers are usually provided on at least three side surfaces of the fluid channel Only the contact surface to the PTC heating assembly is formed by a wall segment bounding the inner surface and the fluid channel.

The receptacle for the PTC heating assembly is usually pocket-shaped. It can be wedge-shaped in cross-section so that, in addition to the PTC heating assembly, it can be inserted into the receptacle in order to brace the PTC heating assembly within the receptacle.

The housing may have a plurality of receptacles formed side by side and in parallel alignment relative to each other. These receptacles are usually slot-shaped recessed in the housing and open to one side. Usually, all receptacles are open to the same side. The opening to the receptacle may be formed from the outset as part of the extruded profile. Likewise, a wall segment covering the insertion side can be formed first by extrusion, which is at least partially removed before insertion of the PTC heating assembly, for example by machining In doing so, webs can remain which bridge the receptacle and accordingly reinforce the housing in the area of the receptacle.

The housing according to the electric heating device of the invention abuts the PTC heating assembly over its entire surface and thus with good thermal conductivity. This good thermal contact with respect to the inner surface of the housing and/or the good electrical contact within the PTC heating assembly can be achieved by a clamping force generated by a wedge element. For this variant, the housing should have good inherent stiffness. Alternatively, the receptacle can also be continuously open in the extrusion direction of the extruded profile. In this case, fluid channels opposite each other and a receptacle between them are connected only at the bottom of the receptacle. It is true that the double-walled structure of the housing for the formation of an insulation chamber leads to a certain stiffening of the bottom. Thus, even in this variant, a certain clamping force can be applied as a result of the stiffness of the housing. Alternatively, the housing can be circumferentially strapped by a clamping element which, after insertion of the PTC heating assembly into the receptacle, effects thermal contact between the inner surfaces of the receptacle and the PTC heating assembly.

The PTC heating assembly can also be inserted into the receptacle as a self-contained unit. In such a unit, the outer surface of the PTC heating assembly is formed by an insulating layer, for example in the form of a ceramic plate. The PTC heating assembly can also be wrapped in an electrically insulating film Such a prefabricated structural unit, which is electrically insulated on its outside, can be inserted into the receptacle and bonded therein with a preferably well heat-conducting adhesive.

These are just a few examples of how the PTC heating assembly in the receptacle can be coupled to the housing in a heat-conducting manner Irrespective of this, the configuration of the PTC heating assembly can be such that the PTC element is in solid contact with the strip conductors. For this purpose, the strip conductor can be electrically contacted with the electrically conductive layer on the PTC element in an arbitrary manner, for example by means of an adhesive connected thereto, which is electrically conductive in itself or is applied so thinly that, due to the roughness of the surface of the PTC element, the metallization provided there is electrically contacted with the strip conductor at least in certain areas or at certain points through the adhesive layer.

The above discussed housing of the electric heating device according to the invention serves to guide the fluid and to accommodate the PTC heating assembly. It is understood that elements for guiding the flow may be provided on the end faces of the housing. Thus, on one end face, a cover can be in fluid-tight contact with the housing, through which the fluid to be heated is diverted between two fluid channels. On the opposite side, a cover may be provided that forms inlet and outlet openings for the fluid to be heated and communicates with two fluid channels. The flow may pass through individual or all fluid channels in parallel or in series. In case of a parallel flow, the inlet opening and flow paths leading to the fluid channels are formed on one end face of the housing, and the outlet opening and flow paths leading thereto are formed on the other end face. The elements provided on the end face for guiding the flow can be connected to the housing in any fluid-tight manner, for example braced, glued or screwed or soldered. A fluid-tight seal can be provided at the phase boundary between the housing and the flow-guiding elements on the end face. The fluid can be a gas or a liquid. The elements effecting the closure of the end face of the housing can be made of metal or plastic. They also have the function of compensating for any elastic deformation due to thermal expansion without loss of tightness. The corresponding elements can also be screwed to each other, with the housing and any seals included, and accordingly braced against each other with the housing interposed.

At least one of the elements can also serve to connect the individual PTC elements to an electrical power supply. The element can also accommodate a control unit in a structural unit, which controls various PTC elements or PTC heating assemblies and, if necessary, groups them into heating circuits. However, such a control unit can also be provided in a separate control housing, which rests on a side surface of the housing. Insofar as power transistors are implemented in such a control device, they can be in heat-conducting contact with an outer surface of the housing and in this way on the one hand dissipate their power loss and on the other hand contribute with their power loss to the heating of the fluid.

### BRIEF DESCRIPTION OF THE DRAWINGS

Further details and advantages of the present invention will be apparent from the following description in conjunction with the schematic drawing. In this drawing:

FIG. 1 shows a top view of the housing of the electric heating device, and

FIG. 2 shows a sectional view along line II-II according to the illustration in FIG. 1.

### DETAILED DESCRIPTION

In the Figures, reference sign 2 characterizes a housing in the form of an extruded aluminum profile which forms three parallel fluid channels 4. A receptacle 6 is provided between each of the fluid channels 4. In each of the receptacles, several PTC elements 8 are provided in the longitudinal direction L of the housing 2 corresponding to the extrusion direction during extrusion. In a manner known, these are accommodated between two contact plates 10 forming an electrical contact and are electrically conductively contacted therewith. Between an inner surface characterized by reference sign 12, which is formed by the housing 2 and laterally bounds the receptacle 6, and the contact sheets 10, there is an electrical insulation 14 which prevents direct electrical contact between the housing 2, which is made of metal and thus electrically conductive, and the contact sheets 10, which are energized with different polarity. In the embodiment shown, this electrical insulation 14 is realized in the form of an electrically insulating film The contact sheets 10 are extended beyond the top of the housing 2 to form terminal lugs 15.

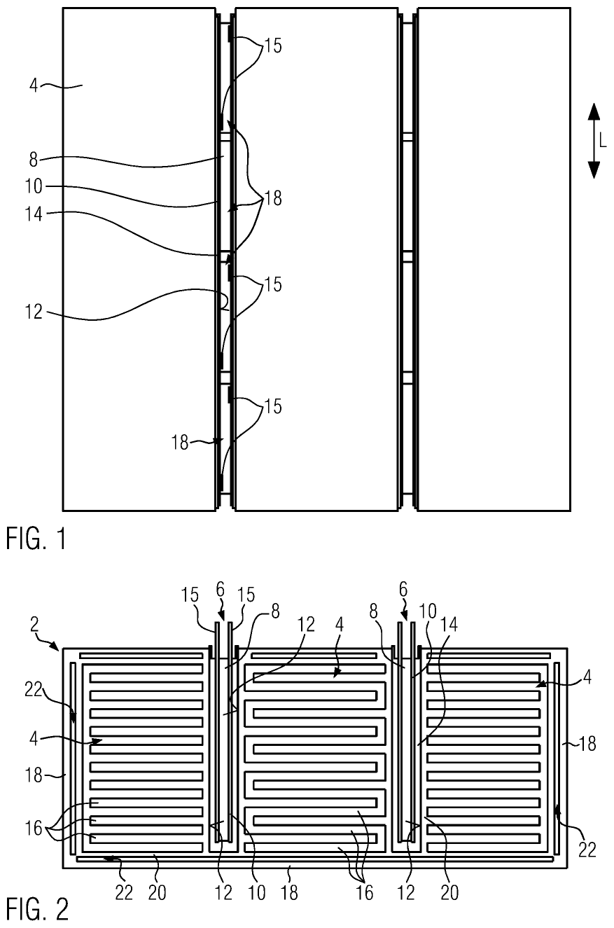

As can be seen from FIG. 1, the housing 2 forms heating ribs 16 within the fluid channels 6. These heating ribs 16 are also formed by the uniform extruded profile. An increased stiffness is also achieved for the housing 2 by means of a double-walled enclosure. A housing outer wall characterized by reference sign 18 is spaced apart from a boundary wall 20 of the fluid channel 4 in each case via an insulation chamber 22. At the corners of the housing 2, insulation chambers 22 provided orthogonally to each other abut and are separated from each other. The double-walled structure not only stiffens the housing 2. Rather, thermal insulation is also formed by the insulation chamber 22. The insulation chamber 22 may be filled with a thermally insulating material. The thermal conductivity of the insulation chamber may also be improved by evacuating the same. Simply providing an air slot between the boundary walls 20 and the outer wall 18 already improves the thermal insulation of the electric heating device on its outside.

In order to increase stiffness, the heating ribs 16 can be configured to be continuous in the width direction. Thus, the boundary wall 20 of the fluid channel 4 forming the inner surface 12 is stiffened by direct connection to the opposite outer boundary wall 20. The central fluid channel 4 has heating ribs 16 that extend only from their associated inner surface 12 and are not connected to the opposite boundary wall 20. This prevents thermal interaction between the PTC heating assemblies provided next to each other. In the sectional view according to FIG. 2, a cavity is formed between the heating ribs 16 in a meandering manner from top to bottom. The flow through this cavity is in longitudinal direction L correspondingly transverse to the drawing plane according to FIG. 2.

The PTC elements 8, which are provided one behind the other in the longitudinal direction L, can each be realized in separate PTC heating assemblies which can be handled separately. They can also be arranged in a common position frame provided between the contact sheets 10 and formed of an electrically insulating material. As previously described, the contact sheets may be provided with insulation on their outside. The positioning frame allows this example of a PTC heating assembly to be handled as a unit and inserted into the receptacle 6.

In the embodiment shown, the heat-conducting insulation of the PTC heating assembly can be achieved by elastic expansion of the receptacle during insertion of the PTC heating assembly. After spreading during installation, the receptacle 6 readjusts to its original dimension. The inner surfaces 12 then abut against the outer surfaces of the PTC heating assembly, preferably in a pretensioned manner. An external tensioning means in the form of a tensioning belt or a tensioning strand, which is wrapped around the circumference of the housing, can reinforce or permanently secure such a pretension.

1. An electric heating device comprising:
a housing forming a receptacle and a fluid channel; and
a PTC element held in the receptacle, wherein the housing is formed by a uniform extruded profile.

2. The electric heating device according to claim 1, wherein the receptacle is dimensioned such that the PTC element holds electrically conductive strip conductors abutting thereon and an insulation, provided between the strip conductors and the receptacle, under pretension.

3. The electric heating device according to claim 2, wherein the PTC element abuts against an inner surface of the housing that decouples the heat under an internal stress generated by the housing.

4. The electric heating device according to claim 1, wherein the extruded profile of the housing forms heating ribs projecting into the fluid channel

5. The electric heating device according to claim 1, wherein the housing forms at least two fluid channels enclosing the receptacle between them.

6. The electric heating device according to claim 1, wherein the extruded profile forms a housing outer wall and an insulation chamber that is provided between an outer wall of the housing and the fluid channel and that is separated from the fluid channel.

7. The electric heating device according to claim 1, wherein insulation chambers, formed by the housing, are provided between all housing outer walls and the fluid channels.

8. The electric heating device according to claim 1, wherein the housing is formed from extruded aluminum or an extruded aluminum alloy.

9. The electric heading device according to claim 1, wherein the housing is formed as a profile part with complex geometry by being molded in a press die and then being cut to a designated length.
